(19) United States
(12) Patent Application Publication
(10) Pub. No.: US 2025/0103996 A1
(43) Pub. Date: Mar. 27, 2025

(54) INTELLIGENT SYSTEMS AND METHODS FOR EMPLOYEE PERFORMANCE EVALUATION

(71) Applicant: DEVONTAE WILLIAMS, HOUSTON, TX (US)

(72) Inventor: DEVONTAE WILLIAMS, HOUSTON, TX (US)

(21) Appl. No.: 18/372,261

(22) Filed: Sep. 25, 2023

(51) Int. Cl. G06Q 10/0639; G06Q 10/04

(52) U.S. Cl. CPC G06Q 10/06398; G06Q 10/04; G06Q 2220/00

(57) ABSTRACT

The invention provides systems and methods for evaluating employee performance using A/I systems and the blockchain to store inputted system data and produced employee data derived from a performance evaluator. More particularly, the A/I based system herein provides highly accurate employee performance assessment, mitigation, improvement and prediction of future performance.

### FIELD OF THE INVENTION

The invention provides systems and methods for evaluating employee performance using artificial intelligence systems for analysis, mitigation and prediction and a blockchain system attached thereto to preserve gathered and created data.

### BACKGROUND OF THE INVENTION

Artificial intelligence systems using machine learning models for item evaluation and predicting future conditions can be obtained by selecting predictive features of input data and generating models using the selected features. Machine learning models use various input data features that can be both evaluative and predictive of desired outcomes. For example, such techniques may include certain well known statistical techniques like regression analysis and/or selecting features based on best fit lines and R-squared values. Traditional, non A/I-backed feature selection techniques may not account for objective cost functions or customizable user performance criteria.

### SUMMARY OF THE INVENTION

Accordingly, the present invention provides a computer-implemented system for tracking, assessing, mitigating, and/or improving employee and/or manager performance (i.e., “the system” or “system”). The invention comprises a sophisticated computer system having one or more processors for executing machine coded instructions; static memory accessible by one or more processors; a computerized artificial intelligence (i.e., A/I) system accessible by the one or more processors having at least one A/I algorithm (i.e., an “A/I engine”) for managing the A/I system; a blockchain system for storing data produced from the A/I system or data supplied to the system overall; and memory storing instructions stored onto the static memory executable by the one or more processors.

Herein, the memory storing instructions cause the system to perform all of the following steps: a) receive real-time work goals and assignments for one or more employees from internal and external sources; b) gather employee performance data based on the completion of the real-time work goals and assignments; and c) it process the employee performance data using artificial intelligence algorithms from the A/I system to generate performance metrics. The system stores performance metrics onto the blockchain system wherein the generated performance metrics are usable for predicting, assessing, mitigating, and improving employee performance immediately and/or over time.

In one preferred embodiment of the computer-implemented system for tracking employee performance herein, the A/I system is decentralized. In this embodiment, the decentralized A/I system comprises two or more A/I engines in a decentralized A/I network.

The A/I system of the computer-implemented system for assessing employee performance herein provides multiple process steps. In practice, the A/I system forms a data set from the collected employee performance data which can be generic, industry specific or individualized work performance data. It then produces an estimate about one or more patterns in the data set. Next, it makes one or more predictions about the data set. Those predictions amounting to assessments of current performance; recommendations; predictions of future performance, and more. Ideally, the A/I system evaluates the one or more predictions for accuracy. It also optimizes the one or more predictions for accuracy and usability.

As noted hereinabove, the blockchain system herein stores employee performance data and any and all data produced by the system whether that data is externally derived or internally created. The blockchain system for storing and managing employee-related performance data preferably comprises: a) a plurality of computing devices interconnected through a communication network; b) one or more distributed ledgers maintained across the plurality of computing devices, wherein each block within the blockchain system includes a timestamped record of employee-related performance data; c) employee data input module configured to receive employee-related performance data from multiple sources, the data including performance metrics and associated metadata; d) a consensus mechanism integrated into the blockchain network; and e) an encryption and access control module that is configured to encrypt either received or created employee-related performance data before appending it to a block in the blockchain. The access control module enforces predetermined access rights to the data based on cryptographic keys.

The blockchain system of the computer-implemented system for tracking employee performance further comprises one or more consensus mechanisms within the blockchain system to validate and secure the stored performance metrics. A consensus mechanism governs the validation and addition of new blocks to the blockchain system and ensures that only authorized participants are able to validate and commit blocks to the blockchain system.

Importantly, the blockchain system further comprises a smart contract module integrated with the blockchain system. The smart contract module comprises one or more programmable contracts that automatically execute predefined actions upon the occurrence of specified conditions within the blockchain system. Herein, the targeted actions are related to employee mitigation, employee improvement, employee incentive, manager mitigation, manager improvement, manager incentive, organizational notice, and organizational rapid response.

Within the computer-implemented system for tracking employee performance, a user interface module is provided that authorizes users with access to the blockchain system. The interface module enables a user of the system herein to submit employee-related performance data, configure access controls, and retrieve performance data using appropriate cryptographic keys.

The blockchain system of the computer-implemented system for tracking employee performance may further comprise a data analytics module that is integrated with the blockchain system. The data analytics module may be a part of the blockchain system itself or held out separately therefrom and in operative communication with the employee performance data module OR the machine learning module. A second or additional data analytics module may also exist separately from the blockchain system but is communicatively connected to the A/I system (i.e., the employee performance module and/or the machine learning module). The data analytics module utilizes the stored employee-related performance data to generate insights, trends, correlations and reports related to employee performance.

The blockchain system provides for one or more smart contracts positioned onto the blockchain system. The smart contracts herein are configured to execute predefined actions based upon employee performance metrics. In greater particularity herein, the smart contracts are configured to provide one or more of the following of employee mitigation, employee improvement, employee incentive, manager mitigation, manager improvement, manager incentive, organizational notice, and organizational rapid response. Preferably, the computer-implemented system for tracking employee performance provides encrypted access controls for authorized users to access and review the performance metrics.

The computer-implemented system for tracking employee performance preferably comprises a system of auditing the blockchain system. Ideally, the system of auditing the blockchain system (i.e., by security audits) is powered by at least one artificial intelligence engine.

In practice, the artificial intelligence system, which is preferably decentralized, is useful for analyzing employee performance trends and patterns from performance metrics stored within the blockchain system. The de-centralized A/I system adjusts and updates the predefined work goals and assignments using artificial intelligence based analysis of each A/I engine and gathered historical employee performance data. As a function of its analysis, the de-centralized A/I system generates dynamic recommendations for performance improvement based upon such artificial intelligence analysis of employee performance data.

Also provided herein is a process for tracking employee performance that comprises a) collecting employee performance data from one or more data sources; b) storing the employee performance data into the blockchain system; c) providing a computer system having one or more processors; d) providing an A/I system for analysis of the employee performance data; e) providing a performance evaluator to analyze the employee performance data; f) providing at least one or more predictions based upon analysis of the employee performance data; and g) using one or more predictions to execute instructions for employee mitigation.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a schematic drawing of the generalized employee performance system herein;

FIG. 2 is a schematic drawing of an exemplary embodiment of the employee performance system herein;

FIG. 3 is a schematic drawing of the manager bias A/I assessment engine herein; and

FIG. 4 is schematic drawing of an alternative exemplary embodiment of the employee performance system of FIG. 1.

### DETAILED DESCRIPTION OF THE INVENTION

The following description is provided as an enabling teaching of the present systems, and methods in its best, currently known aspect. To this end, those skilled in the relevant art will recognize and appreciate that many changes can be made to the various aspects of the present systems and methods described herein while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a”, “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where an event or circumstance occurs and instances where it does not.

The word “or” as used herein means any one member of a particular list and also includes any combination of members of that list. Further, one should note that conditional language, such as, among others, “can”, “could”, “might”, or “may”, unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

By the term “artificial intelligence engine” it is meant herein the theory and development of algorithms imbedded within computer systems that are able to perform tasks that normally require human intelligence and decision-making, such as visual perception, speech recognition, critical thinking, decision-making, and language translation.

The present invention provides a computer-implemented system (i.e., “the system” or “system”) for tracking, assessing, mitigating, and improving employee and/or manager performance. The invention comprises a sophisticated computer system having one or more processors for executing machine coded instructions (e.g., machine learning—M/L—algorithms); static memory accessible by the one or more processors static memory; a computerized artificial intelligence (i.e., A/I) system accessible by the one or more processors having at least one A/I algorithm (i.e., an “A/I engine”) for managing the A/I system; a blockchain system for storing data produced from the A/I system or data supplied to the system overall; and memory storing instructions stored onto the static memory executable by the one or more processors.

Herein, the memory storing instructions cause the system to perform all of the following steps: a) receive real-time work goals and assignments for one or more employees from internal and external sources; b) gather employee performance data based on the completion of the real-time work goals and assignments; and c) it processes the employee performance data using artificial intelligence algorithms from the A/I system to generate performance metrics. The system stores performance metrics onto the blockchain system wherein the generated performance metrics are usable for predicting, assessing, mitigating, and improving employee performance immediately and/or over time.

In one preferred embodiment of the computer-implemented system for tracking employee performance herein, the A/I system is decentralized. In this embodiment, the decentralized A/I system comprises two or more A/I engines in a decentralized A/I network.

The A/I system of the computer-implemented system for assessing employee performance herein provides multiple process steps. In practice, the A/I system forms a data set from the collected employee performance data. It then produces an estimate about one or more patterns in the data set. Next, it makes one or more predictions about the data set, i.e., assessments of current performance; recommendations; predictions of future performance. Ideally, the A/I system evaluates the one or more predictions for accuracy. It also optimizes the one or more predictions for accuracy and usability.

As noted hereinabove, the blockchain system herein stores employee performance data and any and all data produced by the system whether that data is externally derived or internally created. The blockchain system for storing and managing employee-related performance data preferably comprises: a) a plurality of computing devices interconnected through a communication network; b) one or more distributed ledgers maintained across the plurality of computing devices, wherein each block within the blockchain system includes a timestamped record of employee-related performance data; c) employee data input module configured to receive employee-related performance data from multiple sources, the data including performance metrics and associated metadata; d) a consensus mechanism integrated into the blockchain network; and e) an encryption and access control module that is configured to encrypt either received or created employee-related performance data before appending it to a block in the blockchain. The access control module enforces predetermined access rights to the data based on cryptographic keys.

By the term “communication network” it is meant herein a system that enables the digital, electronic exchange of information and data between multiple devices or entities using one or more computerized devices, the internet, BLUETOOTH® connectivity, wireless connectivity and the like.

The blockchain system herein is a decentralized and distributed digital ledger technology that allows multiple parties to have a synchronized and secure record of transactions and data across a network of computers. At its core, the blockchain system is a chain of blocks in which each block contains a list of transactions or data. These blocks are linked together using cryptographic hashes, which create a secure and tamper-resistant chain. Once a block is added to the blockchain, it becomes extremely difficult to alter or delete the information contained within it, providing a high level of immutability and trust. Herein, the terms “blockchain”, “blockchain system”, and “blockchain storage” are interchangeable.

One of the key features of blockchain technology is its immutability., Once data is recorded on the blockchain, it becomes extremely difficult if not impossible to alter or delete it. This is achieved through the use of cryptographic hashing and the consensus mechanism. The consensus mechanism ensures that all nodes within a blockchain network (i.e., the blockchain system) agree on the validity of transactions before they are added to the blockchain system. It governs the validation and addition of new blocks to the blockchain system. It ensures that only authorized participants are allowed to validate and commit blocks to the blockchain system.

Importantly, the blockchain system further comprises a smart contract module integrated within the blockchain system. The smart contract module comprises one or more programmable contracts that automatically execute predefined actions upon the occurrence of specified conditions within the blockchain system. Herein, the targeted actions related to employee mitigation, employee improvement, employee incentive, manager mitigation, manager improvement, manager incentive, organizational notice, and organizational rapid response.

Within the computer-implemented system for tracking employee performance, a user interface module is provided that authorizes users with access to the blockchain system. The interface module allows a user of the system herein to submit employee-related performance data, configure access controls, and retrieve performance data using appropriate cryptographic keys.

The blockchain system of the computer-implemented system for tracking employee performance may further comprise a data analytics module that is integrated with the blockchain system. The data analytics module may be a part of the blockchain system itself or held out separately therefrom and in operative communication with the employee performance data module or the machine learning module. A second or additional data analytics module may also exist separately from the blockchain system but is communicatively connected to the A/I system (i.e., the employee performance module and/or the machine learning module). The data analytics module utilizes the stored employee-related performance data to generate insights, trends, correlations and reports related to employee performance.

The blockchain system of the computer-implemented system for tracking employee performance further comprises one or more consensus mechanisms within the blockchain system to validate and secure the stored performance metrics. Also, the blockchain system provides for one or more smart contracts positioned onto the blockchain system. The smart contracts herein are configured to execute predefined actions based upon employee performance metrics.

In greater particularity herein, the smart contracts are configured to provide one or more of the following of employee tracking, employee assessment, employee mitigation, employee improvement, employee incentive, manager mitigation, manager improvement, manager incentive, organizational notice, and organizational rapid response. Preferably, the computer-implemented system for assessing employee performance provides encrypted access controls for authorized users to access and review the performance metrics.

The computer-implemented system for tracking employee performance preferably comprises a system of auditing the blockchain system. Ideally, the system of auditing the blockchain system (i.e., by security audits) is powered by at least one artificial intelligence engine.

In practice, the artificial intelligence system, which is preferably decentralized, is useful for analyzing employee performance trends and patterns from performance metrics stored within the blockchain system. The de-centralized A/I system adjusts and updates the predefined work goals and assignments using artificial intelligence based analysis of each A/I engine and gathered historical employee performance data. As a function of its analysis, the de-centralized A/I system generates dynamic recommendations for performance improvement based upon such artificial intelligence analysis of employee performance data.

Also provided herein is a process for tracking employee performance is provided herein that comprises a) collecting employee performance data from one or more data sources; b) storing the employee performance data into the blockchain system; c) providing a computer system having one or more processors; d) providing an A/I system for analysis of the employee performance data; e) providing a performance evaluator to analyze the employee performance data; f) providing at least one or more predictions based upon analysis of the employee performance data; and g) using said one or more predictions to execute instructions for employee mitigation.

Ultimately, the enclosed invention and all of its related embodiments center upon an employee's job performance, assessment thereof, mitigation thereof, prediction thereof and possibly, improvement thereof. Job performance is an oft studied and much discussed subject. The top ten measurable job performance criteria or measures can vary depending on the nature of the job and the industry. However, here are some common performance criteria that are often used to evaluate employee performance across jobs and industries. Herein, the terms “worker” and “employee” are interchangeable. Properly defining the requirements of job performance for a given industry, organization and/or locale is paramount.

A list of critical job performance measures by an employee include, but are not limited to, all of the following: a) quality of work; b) productivity; c) attendance; d) communication skills; e) problem-solving skills; f) critical and strategic thinking skills; g) teamwork and collaboration; h) initiative (and proactiveness); i) adaptability; and j) customer/client satisfaction.

Herein, the term “quality of work” measures the accuracy, thoroughness, and overall quality of an employee's output or deliverables. Determination of work quality can be done objectively, subjectively or both. Another work performance measurable is productivity. Productivity seeks to assess the amount of work completed within a given timeframe and compares it to set targets or benchmarks for a given job or industry.

Yet other work performance measurables are attendance and punctuality. These measure a employee's reliability and adherence to the company's attendance policy that can be a factor of predictability for present and/or long term employee viability. Related to these are time management. Time management evaluates the employee's ability to prioritize tasks, manage time efficiently, and meet deadlines.

An employee's communication skills are a clearly valuable measure of a employee's ability to express ideas clearly, listen actively, and maintain effective communication with colleagues and clients. Problem solving abilities assess the employee's capacity to identify and solve work-related challenges and make effective decisions measurable by the time of completion, use of resources and effective results.

Critical thinking is a cognitive skill and intellectual process that involves analyzing, evaluating, and synthesizing information and ideas in a systematic and disciplined manner. It is a way of thinking that goes beyond simply accepting information at face value and instead encourages individuals to question, assess, and challenge what they encounter. Critical thinking is a fundamental skill in problem-solving, decision-making, and learning. Similar to critical thinking is strategic thinking which is a cognitive skill and a mode of thinking that involves the ability to analyze complex situations, identify long-term goals and objectives, and develop effective strategies to achieve them. It is a key component of strategic planning, which is the process of setting priorities, allocating resources, and making decisions to achieve organizational or personal objectives. Strategic thinking is often associated with leadership and is essential in various contexts, including business, government, military, and personal life.

Teamwork and collaboration measure how well an employee works with others, contributes to team goals, and fosters a positive team environment. Initiative and proactiveness are criterion used to evaluate an employee's willingness to take the lead, show initiative, and go above and beyond assigned tasks. Adaptability is used to assess how well a employee can handle change, adjust to new circumstances, and learn new skills. Lastly, customer/client satisfaction measures the level of satisfaction of the customers or clients the employee serves.

It is essential to tailor these criteria to specific job roles and responsibilities to ensure that they accurately reflect an employee's performance and contribute to their development. Moreover, using a mix of quantitative and qualitative measures can provide a more comprehensive evaluation of an employee's job performance. Also, such mixture may also introduce a measure of bias which, when possible, should be avoided and/or mitigated against.

Ideally, all of the above job performance criteria can be objectively assessed, i.e., noted and determined without the specter of human bias grounded in religion, gender, race, ethnicity, sexual orientation or any generally known area of bias. Unfortunately, that is almost never the case as is well known by persons of skill in the art in the area performance reviews and/or impermissible bias in the workplace litigation. The systems and methods herein are particularly adept at limiting and/or avoiding such man-made biases altogether and are discussed further herein.

Smart contracts herein rely upon data inputs (i.e., employee performance data) to evaluate employee performance criteria. These inputs can come from various sources, such as transactions submitted to the blockchain system, external data feeds not attached to the blockchain system, or data stored within the blockchain. When the necessary data inputs are provided to the smart contract, the conditions defined in the contract's code are evaluated. This often involves comparing the provided data with the specified criteria or running algorithms (e.g., machine learning algorithms) on the data to check for specific patterns.

In the blockchain system herein, the verification of the smart contract's conditions is performed by the network's nodes (i.e., those of the blockchain system herein). Each node independently verifies the data and the conditions of the contract. Once a consensus is reached, and the conditions are verified, the contract's execution is triggered. If the conditions are met, the smart contract's actions are automatically executed. These actions could involve transferring digital assets (e.g., cryptocurrency), updating data in the blockchain system (e.g., employee performance and/or manager performance data), thereby triggering other contracts, or any other predefined operation. Once a smart contract is executed and its actions are carried out, the results are recorded in the blockchain system and become immutable. This means that the contract's state and outcome cannot be altered, providing transparency and trust in the smart contract execution process.

Preferred operations of smart contracts herein include but are not limited to alert HR about potentially adverse employee conditions (e.g., in the event of rapid trend spotting) and executable plans for worker mitigation, worker improvement, worker incentive, manager mitigation, manager improvement, manager incentive, organizational notice, and organizational rapid response.

In the context of the blockchain system and smart contracts herein, an oracle input refers to external data or information (e.g., employee performance data) brought into the blockchain network from sources outside of the blockchain. Oracles act as intermediaries that provide this external data to the smart contracts, enabling them to interact with the outside world and make decisions based on real-world events or conditions. Oracles can be centralized or decentralized. Centralized oracles are single entities or services that provide the external data to the smart contract, but they introduce a single point of failure and might be vulnerable to manipulation. Decentralized oracles, on the other hand, rely on multiple sources or consensus mechanisms to ensure the reliability and accuracy of the data.

Decentralized oracles are a type of oracle service that brings external data into a blockchain network in a trustless and decentralized manner. They play a crucial role in smart contracts by providing real-world data to the blockchain, enabling smart contracts to interact with the external environment and to make decisions based on that data. Traditional oracles are centralized entities or services that act as intermediaries between the blockchain and external data sources. While they can efficiently provide data, they can also introduce a single point of failure and might be susceptible to manipulation or data inaccuracies. Decentralized oracles, on the other hand, aim to overcome these limitations by leveraging the principles of decentralization and cryptographic techniques. Herein, decentralized oracles for use with the blockchain system are preferred.

Decentralized oracles work in the following manner. First, decentralized oracles rely on multiple data sources to provide external information. These sources can be various independent entities, databases, metadata sources, APIs, IoT devices, or other decentralized data networks. Next, decentralized oracles aggregate data from multiple sources to determine the most accurate and reliable data point. This aggregation process helps prevent manipulation and ensures the final data is trustworthy.

To further validate the data and ensure consensus on the correct value, decentralized oracles often use consensus mechanisms similar to those used in blockchains. These mechanisms can include voting, staking, or other consensus algorithms. Decentralized oracles may implement reputation systems to assess the reliability and accuracy of data sources. Oracles with a good track record and higher reputation are given more weight in the data aggregation process.

Decentralized oracles may use cryptographic proofs to verify the authenticity and integrity of the data they provide. These proofs are recorded on the blockchain, ensuring transparency and auditability. Once the decentralized oracle has aggregated and verified the external data, it sends this data to the smart contract on the blockchain. The smart contract can then use this information to execute actions or make decisions based on predefined conditions.

In practice, decentralized oracles enhance the security and trustworthiness of smart contracts by reducing the reliance on a single centralized entity and incorporating multiple independent data sources. They enable blockchain applications to interact with the real world and access external data in a decentralized, tamper-resistant, and reliable manner.

In practice, the artificial intelligence system, which is preferably decentralized, is useful for analyzing employee performance trends and patterns from performance metrics stored within the blockchain system. The de-centralized A/I system adjusts and updates the predefined work goals and assignments using artificial intelligence based analysis of each A/I engine and gathered historical employee performance data. As a function of its analysis, the de-centralized A/I system generates dynamic recommendations for performance improvement based upon said artificial intelligence analysis of employee performance data.

By the term “dynamic recommendation” it is meant herein a real-time or continuously updated suggestion or advice provided by the system's algorithms or smart contracts. These recommendations can be related to various aspects of the blockchain ecosystem, including transaction fees, consensus participation, node selection, governance decisions, and more.

The blockchain system herein can support the creation of decentralized A/I models whereby the A/I algorithms are distributed across multiple nodes in the system. This approach can enhance privacy, security, and resilience, as there is no central point of failure. Additionally, the blockchain system herein is useful for managing access controls and permissions for these decentralized A/I models.

Also provided herein is a process for tracking employee performance which provides herein a) collecting employee performance data from one or more data sources and storing the employee performance data into a blockchain system; b) storing the employee performance data into the blockchain system; c) providing a computer system having one or more processors; d) providing an A/I system for analysis of employee performance data; e) providing a performance evaluator to analyze the employee performance data; f) providing at least one or more predictions based upon analysis of the employee performance data; and g) using one or more predictions to execute instructions for employee mitigation.

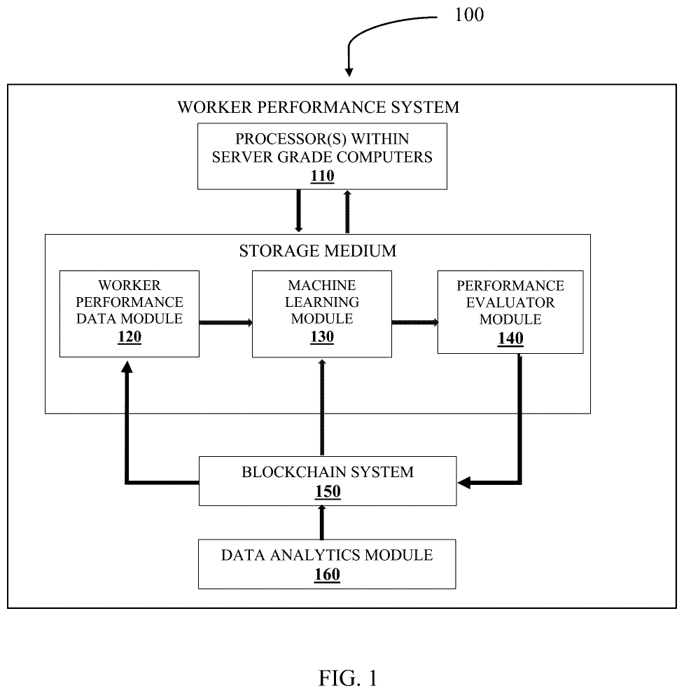

FIG. 1 provides a schematic drawing of employee performance system 100 (i.e., “system 100” or “the system 100”) herein. Employee performance system 100 comprises one or more processors 110 connected to one or more computerized devices (e.g., one or more server grade computers well known by persons of skill in the art), employee performance data module 120, machine learning module 130, performance evaluator module 140, and blockchain storage 150.

In practice, system 100 herein comprises at least one or more server grade computers (i.e., the server), a controller operatively connected to the computer grade server that has at least one central processing unit (i.e., CPU), static memory coupled to at least one CPU herein. The operating software by which to operate the controller, and machine learning module 130. Server grade computers of the type and kind useful for the inventive embodiments herein can be found from DELL®, IBM®, LENOVO®, HEWLETT PACKARD® and the like.

Processors suitable for the execution of system 100 herein include, by way of example, both general and special purpose microprocessors. Generally, a processor will receive instructions and data from read-only memory, random access memory or both. Elements of a computer can include a processor for performing actions in accordance with instructions and one or more memory devices for storing instructions and data. Generally, a computer will also include, or be operatively coupled to receive data from and/or transfer data to one or more mass storage devices for storing data, e.g., magnetic, magneto-optical disks, or optical disks.

Suitable processors for use of the kind contemplated herein include the INTEL® class of processors (i.e., CELERON®, PENTIUM®, and CORE®) and AMD® class of processors (i.e., SEMPRON®, ATHLON® and PHENOM®).

Employee performance data module 120 provides a source of employee performance data derived from either directly within system 100 or from outside of system 100. The data may be initially collected by a company or organization authorized to collect information about its employees, particularly employee performance data. The data is preferably stored on a suitable computerized device (e.g., one or more of the server grade computers discussed hereinabove).

In practice, data stored within employee performance data module 120 can be received from blockchain storage 150 as is shown. Also, employee performance data may also flow to employee performance data module 120 from sources outside of system 100, for example, third party data collection modules (e.g., HR databases, third party job sites like LINKEDIN®) and/or on-site human resource servers. The data is then transmitted to machine learning module 130. Such storage and transmission of employee performance data is facilitated by processors 110. The data can take one or more multiple forms including meta data, text data, binary machine data and more.

Machine learning is a branch of artificial intelligence (A/I) and computer science that focuses on the use of data and algorithms to imitate the way that humans learn, gradually improving its accuracy. Machine learning works upon data received from employee performance data module 120 by machine learning module 130. Machine learning herein can be described as the use and development of computer systems that are able to learn and adapt without following explicit instructions, by using algorithms and statistical models to analyze and draw inferences from patterns in data.

Herein, machine learning uses one or more algorithms or a series of algorithms that perform all of the following functions: 1) forming one or more data sets from the collected location data; 2) producing an estimate about a pattern in the data set; 3) making one or more predictions about the one or more data set 4) rigorously and redundantly evaluating the one or more predictions statistically; and 5) optimizing the prediction(s) for statistical accuracy and adjusts accordingly where necessary.

Even more specifically, machine learning operates in three key ways as follows. First, a decision process occurs in which machine learning algorithms are used to make a prediction or classification. Based on some input data, which can be labelled or unlabeled, the algorithm then produces an estimate about one or more patterns in the work performance data.

Herein, the term “prediction” refers to the output of an algorithm after it has been trained on a historical dataset and applied to new data when forecasting the likelihood of a particular outcome, such as a likely outcome of employee response to no action, mitigating action, incentives or other actions taken by an organization now armed with data from performance evaluator module 140.

In practice, machine learning module 130 uses predictive optimization technology as part of its overall machine learning analysis. Predictive optimization technology is a universal technology that implements decision making, planning and decisions based upon prediction of future outcomes by means of artificial intelligence (A/I).

Second, an error function within the algorithm is provided that serves to evaluate the prediction of the model. If there are known examples, an error function can make a comparison to assess the accuracy of the model formed from machine learning module 130.

Third, a model optimization process is provided in which statistical weights are adjusted in the historical data (i.e., as created by machine learning module 130) sets to reduce the discrepancy between the known example and the model estimate. The algorithm may be programmed to repeat this evaluate and optimize process, updating weights autonomously until a requisite threshold of accuracy has been met. This threshold of accuracy is not arbitrary. It is chosen by the operator of system 100 herein and should correlate closely to the degree of accuracy required depending upon the subject industry, profession, goals, objectives, desired end results and more.

Alternatively, system 100 herein may use deep learning (DL) in addition to or instead of machine learning. The way in which deep learning and machine learning differ is in how each algorithm learns. Deep learning automates much of the feature extraction portion of the process, eliminating some of the manual human intervention required and enabling the use of larger data sets. Deep learning is often referred to as “scalable machine learning”.

Deep learning can leverage labeled datasets, also known as supervised learning, to inform its algorithm, but it doesn't necessarily require a labeled dataset. It can ingest unstructured data in its raw form (e.g., text and images), and it can automatically determine the set of features that distinguish different categories of data from one another. Unlike machine learning, it doesn't require human intervention to process data thereby allowing the system 100 to scale the use of machine learning.

Performance evaluation module 140 uses artificial intelligence algorithms and dynamic probability models to make predictions about employee performance and provide suggestions for employee performance mitigation, incentivization and/or correction (e.g., initiating a employee performance improvement plan).

Artificial Intelligence (A/I) is a branch of computer science that deals with the creation of intelligent agents or systems that can mimic human-like cognitive abilities, such as learning, reasoning, problem-solving, perception, and decision-making. A/I encompasses a wide range of techniques and algorithms, including machine learning, deep learning, natural language processing, computer vision, robotics, and more.

A/I systems leverage data and algorithms to learn patterns and make predictions or decisions without being explicitly programmed for each specific task. Machine learning, a key subset of A/I, often employs probability models to infer patterns and relationships in data and to make informed decisions and predictions.

Dynamic probability modelling and artificial intelligence are closely related concepts, as both play important roles in understanding and predicting complex systems. A dynamic probability model is a mathematical framework used to describe and analyze systems that change over time. It is a probabilistic model that calculates the uncertainty and variability inherent in dynamic processes, conditions and systems. Such models are often employed in various fields, including statistics, engineering, finance, and are useful for the system 100 herein.

The relationship between dynamic probability models (i.e., the algorithms therefor) and A/I algorithms provided by performance evaluator module 140 are multi-fold. Within the dynamic probability modeling provided in this invention are four critical functions which are the following: a) predictive analysis; b) time series analysis; c) reinforcement learning; and d) uncertainty modeling.

Predictive analysis, also known as predictive modeling, is a key feature of dynamic probability modeling in which historical data and statistical techniques are used to make predictions about future events or outcomes. The goal of predictive analysis is to identify patterns in past data and use those patterns to make informed predictions about what might happen next.

In general, predictive analysis comprises the steps of a) data collection and preparation; b) feature selection and engineering (i.e., identifying which variables or features—these terms are interchangeable—are most relevant to a given prediction task); c) model selection (i.e., the choosing of one or more algorithms to build predictive models, such as linear regression, decision trees, random forests, support vector machines, and/or neural networks); d) training the model(s); e) validation and evaluation; f) model tuning (i.e., the process of setting how the model learns); g) prediction (i.e., once the model is trained and validated, the model produces a prediction of one or more future outcomes as set by the desired features); and h) continuous monitoring and maintenance of the model.

Dynamic probability models are often used in A/I for predictive analytics tasks. In general, A/I systems can learn from historical data and capture the dynamics of a system using dynamic probability models. These models can then be used to forecast or predict future outcomes or behavior.

Many real-world problems involve time-dependent data, such as stock prices, weather patterns, or traffic flow. Dynamic probability models, such as hidden Markov models, dynamic Bayesian networks, or state-space models, are commonly used in A/I to analyze and to make predictions. In reinforcement learning, an A/I agent learns to make decisions and take actions to achieve a goal in an environment. Dynamic probability models can be used to represent the uncertainty in the environment and help the agent estimate the best actions to take in different situations.

With respect to uncertainty modeling, A/I systems often encounter uncertainty due to incomplete or noisy data. Dynamic probability models enable A/I systems to reason under uncertainty and provide accurate, high-value probabilistic estimates of outcomes, which can lead to more robust and reliable decision-making.

Overall, the relationship between dynamic probability (DP) models and A/I is symbiotic with A/I providing the raw computing power and robust calculation strength while DP provides the statistical means for feature insight and reliable predictions. Dynamic probability models provide the foundation for handling uncertainty and temporal dependencies in A/I systems, making them more adaptable, accurate, and capable of dealing with real-world complexity. On the other hand, A/I techniques leverage dynamic probability models to create intelligent systems that can effectively model and predict dynamic processes. In a dynamic probability model, the parameters or states of the system are represented as random variables, and the model captures how these variables evolve over time based on probabilistic rules. By incorporating probabilities and uncertainties, dynamic probability models allow for more realistic and flexible representations of real-world phenomena that exhibit temporal patterns or changes.

Blockchain storage system 150 exists (or storage blockchain 150) as part of an overall blockchain system herein which is, preferably, decentralized. As noted hereinabove, the blockchain system herein stores employee performance data (i.e., received and/or generated) and any and all data produced by the system. Blockchain system 150 provides for storing and managing of employee related and manager related performance data preferably comprises: a) a plurality of computing devices (i.e., server grade computers with one or more CPUs) interconnected through a communication network; b) a distributed ledger maintained across the plurality of computing devices, wherein each block within said blockchain system includes a timestamped record of employee related performance data; c) an employee data input module configured to receive employee-related and manager related performance data from multiple sources, the data including performance metrics and associated metadata; d) an integrated consensus mechanism; and e) an encryption and access control module that is configured to encrypt either received or created employee-related performance data before appending it to a block in blockchain storage system 150. The access control module enforces predetermined access rights to the data based on one or more cryptographic keys.

Employee system 100 performance preferably comprises a system of auditing blockchain system 150. Ideally, the system of auditing the blockchain system is powered by at least one artificial intelligence system or engine. Blockchain security audits are comprehensive assessments conducted on a blockchain system or application to identify potential vulnerabilities, weaknesses, and security risks. The goal of these audits is to ensure the integrity, confidentiality, and availability of blockchain system 150 and its associated components. A blockchain security audit aims to identify and mitigate potential threats, such as hacking attempts, data breaches, unauthorized access, and malicious activities.

Key components of a blockchain audit (i.e., “security audit”) include all of the following: a) scope definition; b) threat modeling; c) architecture review; d) smart contract review; e) penetration testing; f) cryptographic analysis; g) access control review; h) network security analysis; i) data privacy and compliance; j) report generation; and k) remediation and follow-up.

Scope definition is the first step to define the scope of the block chain audit. This includes identifying the specific blockchain system, smart contracts, applications, and associated components to be audited. This helps in focusing the audit in the relevant areas.

In threat modeling, auditors analyze potential threats and attack vectors that could compromise the security of the blockchain system. This involves considering various scenarios, such as unauthorized access, code vulnerabilities, insider threats, and more.

In architecture review, auditors examine the architecture of the blockchain system, including its design, consensus mechanism, data storage, and communication protocols. This helps in identifying any architectural flaws that might lead to security vulnerabilities.

In smart contract review, for blockchains with smart contract functionality, auditors review the code of these contracts to identify coding vulnerabilities and potential exploits. Common issues include reentrancy attacks, integer overflows, and logic errors.

Penetration testing involves actively trying to exploit vulnerabilities in the system by mimicking potential attacks by malicious actors. This phase can uncover vulnerabilities that might not be evident through code review alone.

In cryptographic analysis, blockchain systems heavily rely on cryptography for security. Auditors assess the cryptographic algorithms, key management processes, and encryption mechanisms to ensure that they are implemented correctly.

In access control review, auditors evaluate the access control mechanisms to ensure that only authorized users have appropriate access to the system. This includes user authentication, role-based access control, and permissions management.

The network infrastructure supporting blockchain system 150 is reviewed to identify potential points of entry for attackers. This network security analysis includes examining firewalls, intrusion detection systems, and other network security measures.

In data privacy and compliance, depending upon the application, auditors assess whether blockchain system 150 complies with relevant data privacy regulations such as General Data Protection Regulation (GDPR). They also ensure that sensitive data is properly encrypted and managed.

After conducting the audit, auditors compile a detailed report (i.e., report generation) that includes their findings, identified vulnerabilities, recommended mitigation strategies, and steps to improve the system's overall security.

With respect to remediation and follow-up, the organization that owns blockchain system 150 herein will take the recommended actions to address identified vulnerabilities and weaknesses. Auditors might also conduct a follow-up assessment to ensure that recommended changes have been implemented effectively.

As noted hereinabove, blockchain security audits are essential to maintain the trustworthiness and security of a given blockchain network or system, especially in sectors like finance, supply chain, healthcare, employee performance reviews, human resources, manufacturing and the like in which data integrity and security are paramount. These audits help organizations and systems detect and address potential security issues before they can be exploited by malicious actors, ultimately enhancing the overall accuracy, truthfulness and robustness of blockchain system 150.

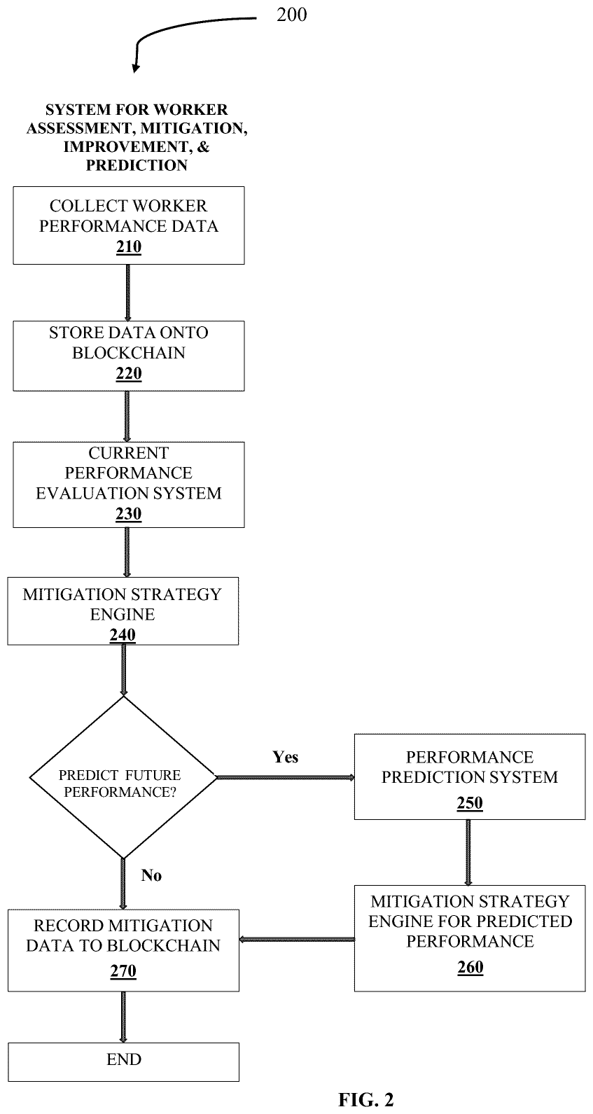

FIG. 2 provides a schematic drawing of an exemplary systemic embodiment herein (i.e., that of FIG. 1) and also provides insight as to the process oriented nature of employee performance system 100. More specifically, it provides for a system for employee assessment, improvement and prediction 200 (i.e., “system 200”).

The first step thereof is to collect employee performance data 210, which, as noted hereinabove, can derive from a myriad of sources: e.g., one or more server grade computers controlled by human resources (i.e., “HR”), one or more blockchain ledgers (possibly but not necessarily controlled by HR), and/or one or more server grade computers maintained and controlled outside of HR and/or a subject or third party organization.

Next, collected data is either transmitted to blockchain 220 and or directly transmitted to current performance evaluation system 230. If employee performance data is first transmitted to blockchain 220, it is stored on one or more blockchain ledgers held therewithin.

Current performance evaluation system 230 provides assessment for the current, as of the day used, performance of an employee. This assessment is performed by machine learning module 120 (shown in FIG. 1). In practice, performance evaluation system 230 uses algorithms and statistical models to analyze and draw inferences from patterns in employee performance data. By this work, system 230 learns and adapts acquired employee performance data that is highly accurate.

Such accuracy of results and/or predictions is fostered by the work of machine learning module 130, the raw computer power of employee performance system 100 (i.e., the one or more processors used therein), industry data and generic employee performance data. Industry data herein is data derived from a given industry (e.g., telecommunications, computer, automotive, petroleum, consumer goods) that contains critical or key employee performance criteria as to that industry. Such criteria, per industry, serves as a basis for employee performance comparisons for a given industry based upon standardized criteria (e.g., work performance of mechanical engineers; marketing professionals; chemists; doctors, coaches and more).

This industry data is used to help build the data sets formed by machine learning module 130. Additional data that is preferably provided is genericized (i.e., made anonymous) employee performance data. Such data can also be used in the data sets created by machine learning module 130. Herein, machine learning module 130 provides an algorithm or a series of algorithms that perform all of the following functions: 1) it redundantly collects multiple kinds of employee performance and industry data; 2) it then forms one or more data sets from the collected data; 3) it next produces an estimate about a discernible pattern in the data set; 4) it can next make one or more predictions about the one or more data sets; 5) it rigorously and redundantly evaluates the one or more predictions statistically; and 6) it optimizes the prediction(s) for statistical accuracy and adjusts accordingly where necessary. By the term “prediction” herein it is meant 1) an actual prediction of future employee or manager performance; or 2) an assessment of current performance based upon current data.

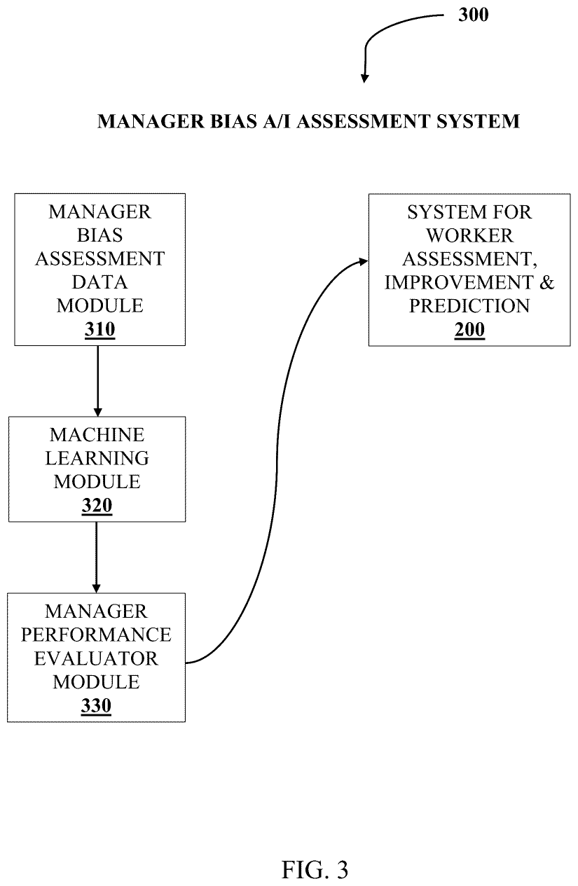

FIG. 3 provides a schematic drawing of the manager bias A/I assessment system 300 herein. Provided herein are manager assessment data module 300, machine learning module 320, manager performance evaluator module 330, and employee performance blockchain storage 340.

As noted hereinabove, employee performance assessment comprises multiple data sources: 1) current employee performance data; 2) industry data; 3) generic employee performance data; and now 4) manager bias assessment data. “Manager bias assessment data” is defined herein as data regarding a manager's performance with respect to direct reports thereto particularly looking for trends in management performance related to gender, religion, ethnicity, age and race.

As is shown in manager bias A/I assessment system 300, the first step is to collect manager bias assessment data 310, which, as noted hereinabove, can derive from a myriad of sources: e.g., one or more server grade computers controlled by human resources (i.e., “HR”), one or more blockchain ledgers (possibly but not necessarily controlled by HR), and/or one or more server grade computers maintained and controlled outside of HR and/or a subject organization or other third party.

Herein, machine learning module 320 is an algorithm or a series of algorithms that perform all of the following functions: 1) it redundantly collects multiple kinds of manager performance, industry data and more; 2) it then forms one or more data sets from the collected data; 3) it next produces an estimate about a pattern in the data set; 4) it can next make one or more predictions about the one or more data sets; 5) it then rigorously and redundantly evaluates the one or more predictions statistically; and 6) it optimizes the prediction(s) for statistical accuracy and adjusts accordingly where necessary.

Next, collected data is either transmitted to blockchain 220 and/or directly transmitted to current performance evaluation system 230. If employee performance data is first transmitted to blockchain 220, it is stored on one or more blockchain ledgers held therewithin.

Manager performance evaluator module 330 provides an assessment for the current, as of the day used, performance of a manager overseeing one or more employees. In practice, manager performance evaluator module 330 uses algorithms and statistical models to analyze and draw inferences from patterns in the employee performance data. By these tasks, system 300 learns and adapts the acquired manager bias assessment data that is as accurate as is possible.

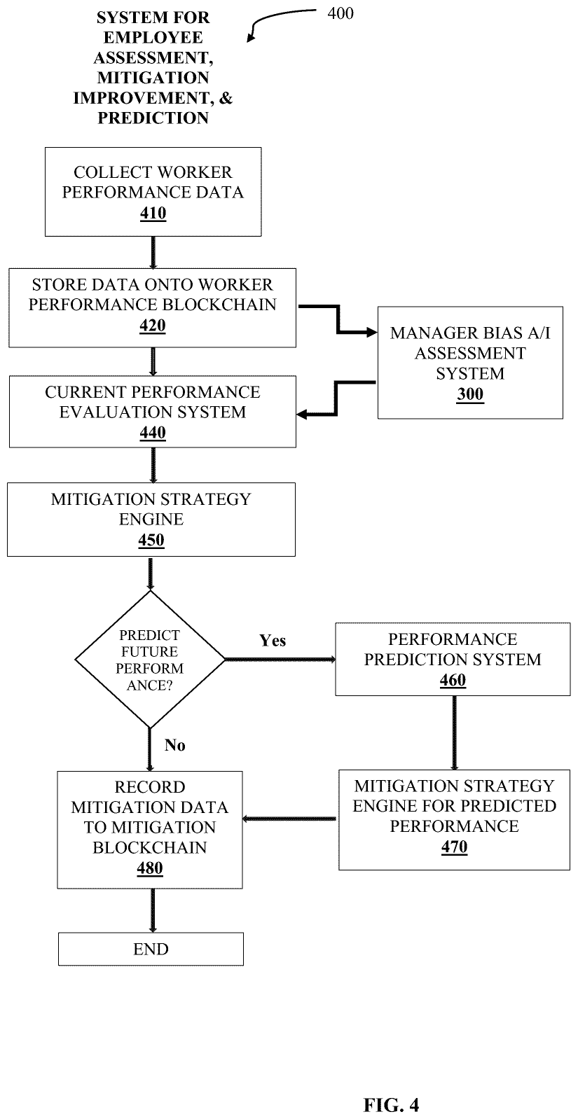

FIG. 4 is a schematic drawing of an alternative exemplary embodiment of FIG. 2; i.e., system for employee assessment, improvement and prediction 400 or “system 400”. This alternative embodiment provides for the addition of manager bias data derived from manager bias A/I assessment system 300 (FIG. 3) specifically coming from manager performance evaluator module 330.

In practice, system 400 is similar to system 300 except that for system 400, manager bias data is added as part of the assessment process for employee performance. Because persons of skill in the art well understand that manager bias often improperly skews evaluation of employee performance, understanding the extent of manager bias and being able to predict such manager bias further aids to make accurate assessment of employee performance.

Once data has been acquired through manager performance evaluator module 330, it is then transmitted back to employee performance system 100 and fed, ultimately, to current performance evaluation system 440 (as shown in FIG. 4). Data from manager bias A/I assessment system 300 serves as an integral check and important add to the alternative system embodiment (i.e., the SYSTEM FOR EMPLOYEE ASSESSMENT, MITIGATION, IMPROVEMENT & PREDICTION 400) provided in FIG. 4 herein.

The first step for system 400 is to collect employee performance data 410, which, as noted hereinabove, can derive from a myriad of sources: e.g., one or more server grade computers controlled by human resources (i.e., “HR”), one or more blockchain ledgers (possibly but not necessarily controlled by HR), and/or one or more server grade computers maintained and controlled outside of HR and/or a subject organization or other third party.

Next, collected data is either transmitted to blockchain 420 and or directly transmitted a current performance evaluation system 430. If employee performance data is first transmitted to blockchain 420, it is stored on one or more blockchain ledgers held therewithin.

Current performance evaluation system 430 provides assessment for the current, as of the day used, performance of a employee. This assessment is performed by machine learning module 120 (FIG. 1). In practice, performance evaluation system 430 uses algorithms and statistical models to analyze and draw inferences from patterns in the employee performance data. By this work, system 430 learns and adapts the acquired employee performance data that is as accurate as is possible.

Blockchain and Artificial Intelligence (A/I) are two distinct technologies, but they can complement one another to create synergies and compatibilities. For example, some areas of compatibility are as follows: a) data integrity and trust; b) data marketplaces; c) decentralized A/I modelling; d) A/I-driven analysis of blockchain data; e) A/I use in blockchain applications; and f) oracles for smart contracts as noted hereinabove.

For data integrity and trust, A/I algorithms heavily rely on high-quality and reliable data for training and decision-making. The blockchain's immutability and transparency can ensure that the data used for A/I training is authentic and untampered. This integrity and trust enhances the trustworthiness of the A/I system herein and substantially prevents data manipulation and/or bias.

The blockchain system 150 herein can also facilitate secure data marketplaces in which individuals or organizations share data while retaining ownership and control thereof. System operators herein can access these data marketplaces to obtain diverse datasets for training their models, an important feature of the inventive embodiments herein.

In preferred practice herein, blockchain system 150 supports the creation of decentralized A/I models in which A/I algorithms are distributed across multiple nodes within blockchain system 150 herein. This approach enhances privacy, security, and resilience, as there is no central point of failure. Additionally, blockchain system 150 can be used to manage access controls and permissions for these decentralized A/I models. Persons of skill in the art will understand the programming necessary to manage such access controls and permissions for particular execution of decentralized A/I models herein.

Artificial intelligence herein can also be employed to analyze and extract insights from the vast amounts of data stored on blockchain system 150. In practice, this is beneficial in identifying patterns, anomalies, and trends in employee performance that provides improvements to overall efficiency of the blockchain system and/or enhance decision-making processes within the system.

As has been noted hereinabove, preferred blockchain system 150 herein incorporates one or more A/I algorithms therein. For example, A/I can be used to optimize blockchain consensus mechanisms, predict network behavior, or enhance performance in decentralized applications. A/I powered oracles can provide real-world data to smart contracts on the blockchain. These oracles act as bridges between the blockchain and external data sources, enabling smart contracts to respond to real-time events and information provided by A/I algorithms.

Disclosed herein are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

It should be appreciated and understood that the present invention may be embodied as systems, methods, apparatus, computer readable media, non-transitory computer readable media and/or computer program products. The present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. The present invention may take the form of a computer program product embodied in one or more computer readable medium(s) having computer readable program code embodied thereon.

One or more computer readable medium(s) may be utilized, alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing.

Other examples of suitable computer readable storage medium include, without limitation, the following: an electrical connection having one or more wires, a portable computer diskette, a hard disk, random access memory (RAM), read-only memory (ROM), an erasable programmable read only memory (EPROM or flash memory), optical fiber, an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and the like, or any suitable combination of the foregoing.

Computer program code for carrying out operations for aspects of the present invention may be written in any combination of one or more programming languages, including an object oriented programming language such as Java, Python, C++ or the like and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider).

The present invention is described herein with reference to flowchart illustrations and/or block diagrams and can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions that execute the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flowchart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for executing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for evaluating employee performance, comprising:
a. One or more processors positioned onto one or more server grade computers;
b. Non-transitory computer readable storage medium resident upon one or more said server grade computers;
c. A blockchain system resident upon one or more said server grade computers for storing data produced from said computer-implemented system;
d. An artificial intelligence system comprising one or more machine learning algorithms resident upon one or more said server grade computers accessible by said one or more processors, said artificial intelligence system providing instructions that, when executed upon by said one or more data processors, cause said one or more data processors to perform operations comprising;
i. Receiving real-time work goals and assignments for one or more employees;
ii. Calculating employee performance data based on the completion of said real-time work goals and assignments;
iii. Processing said employee performance data using said machine learning algorithms from said artificial intelligence system to generate a employee performance evaluation; and
iv. Storing said employee performance evaluation onto said blockchain system,
Wherein said generated performance evaluations are usable for predicting/improving employee performance.

2. The system for evaluating employee performance of claim 1 wherein said artificial intelligence system is decentralized.

3. The system for evaluating employee performance of claim 2 wherein said decentralized artificial intelligence system comprises two or more artificial intelligence engines in a decentralized artificial intelligence network.

4. The system for evaluating employee performance of claim 1 wherein said artificial intelligence system comprises the steps of:
i. Forming a data set from the collected employee data;
ii. Producing an estimate about one or more patterns in the data set; and
iii. Making a prediction about the data set.

5. The system for evaluating employee performance of claim 4 wherein said artificial intelligence system further comprises the step of evaluating said prediction about said data set.

6. The system for evaluating employee performance of claim 5 wherein said artificial intelligence system further comprises the step of optimizing said prediction for accuracy.

7. The system for evaluating employee performance of claim 6 further employing said artificial intelligence to analyze employee performance trends and patterns from said stored performance metrics.

8. The system for evaluating employee performance of claim 1 wherein said de-centralized artificial intelligence system adjusts and updates said predefined work goals and assignments using artificial intelligence analysis of each said artificial intelligence engine and said gathered historical employee performance data.

9. The system for tracking employee performance of claim 8 wherein said de-centralized artificial intelligence system generates dynamic recommendations for performance improvement based upon said artificial intelligence analysis of employee performance data.

10. The system for evaluating employee performance of claim 1 wherein said blockchain system for storing and managing employee-related performance data, comprises:
a. A plurality of server grade computers interconnected through a communication network;
b. One or more electronic blocks for data storage positioned within said blockchain system;
c. A distributed ledger maintained across said plurality of server grade computers, wherein each said electronic block within said blockchain system includes a time stamped record of employee-related performance data;
d. A employee data input module configured to receive employee-related performance data from multiple sources, said data including performance metrics and associated metadata;
e. A consensus mechanism integrated into said blockchain system, said consensus mechanism governing the validation and addition of new said electronic blocks to said blockchain, and ensuring that only authorized participants are allowed to validate and commit said electronic blocks to said blockchain system; and
f. An encryption and access control module configured to encrypt the employee-related performance data before appending it to a said electronic block in said blockchain system, wherein said access control module enforces predetermined access rights to data based on cryptographic keys.

11. The system for evaluating employee performance of claim 10 wherein said blockchain system further comprises a smart contract module integrated with said blockchain system, said smart contract module comprising one or more programmable contracts that automatically execute predefined actions upon the occurrence of specified conditions within said blockchain system.

12. The system for evaluating employee performance of claim 11 having a user interface module providing authorized users with access to said blockchain system, allowing said authorized users to submit employee-related performance data, configure access controls, and retrieve performance data using appropriate cryptographic keys.

13. The system for evaluating employee performance of claim 12 wherein said blockchain system further comprises a data analytics module integrated with the blockchain network, the data analytics module utilizing the stored employee-related performance data to generate insights, trends, and reports related to employee performance.

14. The system for evaluating employee performance of claim 12 wherein said one or more smart contracts are configured to execute predefined actions based on said performance metrics.

15. The system for evaluating employee performance of claim 14 wherein said smart contracts are configured to provide one or more of the following of employee mitigation, employee improvement, employee incentive, manager mitigation, manager improvement, manager incentive, organizational notice, and organizational rapid response.

16. The system for evaluating employee performance of claim 12 wherein said blockchain system is decentralized.

17. The system for evaluating employee performance of claim 12 further comprising a system of auditing said blockchain system.

18. A process for tracking employee performance, comprising:
a. Collecting employee performance data from one or more data sources and storing said employee performance data into a blockchain system;
b. Storing said employee performance data into said blockchain system;
c. Providing a computer system having one or more
d. Providing an artificial intelligence system for analysis of said employee performance data;
e. Providing a performance evaluator to analyze said employee performance data;
f. Providing at least one or more predictions based upon analysis of said employee performance data; and
g. Using said one or more predictions to execute instructions for employee mitigation.
